(19) United States
(12) Patent Application Publication
(10) Pub. No.: US 2022/0214652 A1
(43) Pub. Date: Jul. 7, 2022

(54) SECURE BUILDING SERVICES NETWORK

(71) Applicant: View, Inc., Milpitas, CA (US)

(72) Inventors: Nitesh Trikha, Pleasanton, CA (US); Stephen Clark Brown, San Mateo, CA (US); Dhairya Shrivastava, Los Altos, CA (US)

(21) Appl. No.: 17/612,992

(22) PCT Filed: Jun. 4, 2020
(86) PCT No.: PCT/US2020/070123

§ 371 Date: Nov. 19, 2021

Related U.S. Application Data
(60) Provisional application No. 62/858,634, filed on Jun. 7, 2019.

(51) Int. Cl. G05B 15/02; H04L 9/08

(52) U.S. Cl. CPC G05B 15/02; H04L 9/0894; H04L 2209/80; H04L 2209/38; H04L 9/0838

(57) ABSTRACT

A building services network, which may include a network of sensor devices, is securable via an onboarding process. In addition to the use of encryption keys stored in memory elements of the devices, an onboarding process may additionally utilize a distributed ledger, which is stored among members of a peer group to provide consensus-based authentication of newly added sensors. Such consensus-based authentication of an onboarding process may preclude insertion of falsified data into the building services network. Consensus-based authentication may also be utilized to ensure that newly requested services, and/or upgrades to existing services, comply with predetermined service contracts among network elements of the building services network. Further, consensus-based authentication may also be utilized to authenticate and/or validate individual message transmissions between or among network elements of a building services network or between or among network elements and processing/data collection entities external to the building services network.

### INCORPORATION BY REFERENCE

A PCT Request Form is filed concurrently with this specification as part of the present application. Each application that the present application claims benefit of or priority to as identified in the concurrently filed PCT Request Form is incorporated by reference herein in its entirety and for all purposes.

### BACKGROUND

In a multistory building, for example, a building services network may be utilized to provide control and/or monitoring of building services as well as to provide communications among various distributed components of the building services network. Such building services may include heating, ventilation, and air conditioning (HVAC), perimeter security, lighting control, audio signal distribution, fire detection and suppression, air-quality sensing, temperature/humidity sensing, and so forth. In a building equipped with an electrochromic window system, which may permit windows to be tinted via application of a voltage signal applied to the one or more electrochromic windows, the building services network may operate to provide control and/or monitoring of elements of the electrochromic window system. Accordingly, a building services network may be utilized to communicate a large number of parameters among diverse elements of the network. To provide such capabilities, the building services network may include a complex infrastructure that involves user interfaces, switches/routers, controllers, processors to provide access one or more databases, and so forth.

However, in view of the diverse tasks performed by a building services network, the network may present a number of opportunities for malicious parties to subvert and/or undermine building operations. For example, an unauthorized party, attempting to gain access to a building, may wish to insert false or misleading message parameters into a building services network utilized to provide perimeter security and/or access control. In another instance, an unscrupulous competitor may attempt to obtain access to audio signals obtained from particular conference rooms of the building in order to gain access to sensitive business communications. Additionally, delineation of network services among tenants, occupants, and/or regions of a building may need to be enforced. Thus, techniques for securing the building services network continue to be an active area of investigation.

### SUMMARY

Certain non-limiting implementations of this disclosure may concern secure building services networks. In one or more implementations, a method of authenticating a network element to communicate on a building services network may include, at a manufacturing site of the network element, identifying and storing an encryption key in a nonvolatile memory of the network element. The method may additionally include use of a secure data repository for storage of the encryption key along with a unique identifier of the network element. The method may additionally include coupling the network element to the building services network at a building site. The method may include authenticating the network element at the building site by comparing the encryption key stored in the nonvolatile memory of the network element with the encryption key stored in the secure data repository. In one or more implementations, after coupling the network element to the building services network, the method may include commissioning the network element by determining a correspondence between (a) an installed location of the network element at the building site, and (b) an identifier of the network element coupled to the building services network. The encryption key may be derived utilizing unique parameters of the network element, for example. In some implementations the unique parameters of the network element correspond to a serial number of the network element or to a universal unique identifier (UUID) of a processor of the network element.

In one or more implementations, the above-described method may further include, after authenticating the network element, storing identifying parameters of the network element in a distributed ledger. Storing the identifying parameters in the ledger may include transmitting the identifying parameters to a plurality of network elements coupled to the building services network. A network element can, at least in particular implementations, correspond to a temperature sensor, a humidity sensor, a glass breakage sensor, a movement detector, a carbon dioxide detector, a carbon monoxide detector, a fire detection sensor, a camera, or an air quality sensor.

In one or more implementations, a method of providing a service in a building having a building services network may include receiving a request to activate the service and, via a peer-to-peer network, evaluating the received request for compliance with one or more defined criteria pertaining to authentication of the service. The method may include, responsive to evaluation by the peer-to-peer network of the received request, determining that the service is to be activated and activating the service. Evaluation of a received request may involve performing a blockchain procedure. In one or more implementations, the service may comprise a wireless communications service. The communications service may include a Wi-Fi service, a cellular telephone service, a Bluetooth service, or Citizens Broadband Radio Service band, for example. Activating the service may include providing the service, via the building services network, exclusively to a portion of the building. The activating of the service may comprise providing the service, via the building services network, exclusively to a tenant of the building.

In one or more implementations, the peer-to-peer network may include a plurality of peer devices coupled to the building services network. The peer-to-peer network may include network elements owned by, leased by, or under the control of, an enterprise providing the service to at least a portion of the building via the building services network. In implementations, one or more defined criteria pertaining to authentication of the service may include application of analytics to measurements performed by sensors of the building services network, transmission of measurements performed by sensors to one or more public utility companies, or transmission of measurements performed by sensors to a health and safety monitoring service.

In one or more implementations, authenticating a communication between a first network element and a second network element, in which the first network element is installed in a building and coupled to a building services network, may include determining that the communication is being transmitted, or is to be transmitted, from the first network element over the building services network. Such transmission may be evaluated via a peer-to-peer network to determine or to assess compliance of the communication for one or more defined criteria pertaining to authentication of the communication. Via evaluation by the peer-to-peer network, it may be determined that the communication is not to be delivered to the second network element. In one or more implementations, a communications to a second network element may be prevented. In one or more implementations, the one or more defined criteria pertaining to authentication of communications comprises determining if the communication is permitted by a cellular subscriber service contract, by an agreement to provide analytics services, or an agreement to provide low-latency communications channels.

In certain implementations, the first network element may correspond to a temperature sensor, a humidity sensor, a glass breakage sensor, a movement detector, a carbon dioxide detector, a carbon monoxide detector, a fire detection sensor, a camera, or an air quality sensor. A peer-to-peer network may include a plurality of devices from a peer group or from a peer subgroup of network elements coupled to the building services network. The peer group or subgroup of network elements may correspond to devices owned or controlled by an enterprise tenant. In one or more implementations, the peer-to-peer network may evaluate compliance of a communication via a blockchain procedure. When the first network element corresponds to a sensor, a communication may include a measurement performed by the sensor. When the first network element corresponds to a processor or a device comprising a processor, the communication may include a result of an analytic derived from one or more measurements performed by the sensor. The analytic may include a compliance report, for example, for use by a government entity, a standards body, or a certification entity.

### BRIEF DESCRIPTION OF THE DRAWINGS

FIG. 1 is a diagram of an architecture of a building services network, according to an implementation.

FIG. 2 is a flowchart for a method of onboarding an element of the building services network, according to an implementation.

FIG. 3 is a diagram of a network element showing processor-accessible and protected memory areas for storage of security keys, according to an implementation.

FIG. 4 is a flowchart for a method of authenticating an element of a building services network using a ledger distributed among a peer group, according to an implementation.

FIG. 5 shows a sample site-level ledger for elements of a building services network, according to an implementation.

FIG. 6 is a flowchart for a method of authenticating a service performed by a building services network, according to an implementation.

FIG. 7 is a diagram showing a peer group of network elements, in which each network element is indicated as storing a copy of a distributed ledger, according to an implementation.

FIG. 8 is a diagram showing a peer group of network elements internal to a building services network as well as computing devices external to the building services network, according to an implementation.

### DETAILED DESCRIPTION

The following detailed description is directed to certain embodiments or implementations for the purposes of describing the disclosed aspects. However, the teachings herein can be applied and implemented in a multitude of different ways. In the following detailed description, references are made to the accompanying drawings. Although the disclosed implementations are described in sufficient detail to enable one skilled in the art to practice the implementations, it is to be understood that these examples are not limiting; other implementations may be used and changes may be made to the disclosed implementations without departing from their spirit and scope. Additionally, it should be understood that the conjunction “or” is intended herein in the inclusive sense where appropriate unless otherwise indicated; for example, the phrase “A, B, or C” is intended to include the possibilities of “A,” “B,” “C,” “A and B,” “B and C,” “A and C,” and “A, B, and C.”

While the disclosed implementations focus on approaches (e.g., system, apparatus, method, etc.) toward securing a building services network that may include control elements for controlling a state of one or more electrochromic windows, concepts disclosed herein may apply to other types of service networks including, for example, service networks utilized for automobile passenger compartments, service networks utilized for waterborne craft (e.g., cruise ships, container ships, naval vessels, etc.), as well as other types of single or multi-compartmented structures (e.g., apartment buildings) and claimed subject matter is not limited in this respect.

As previously mentioned herein, a building services network may present numerous opportunities for malicious parties to subvert or undermine building operations.

Building operations may be undermined, for example, by an intruder surreptitiously inserting false data into an information stream from one or more perimeter security sensors of the building. Such insertion of falsified data may permit an intruder to gain unauthorized access to building personnel, business-sensitive documents and/or computer files, trade secrets, physical assets (e.g. computers, monitors, network equipment), and so forth. In another example, insertion of falsified data into an information stream of a building services network may disrupt operations of an entire building, such as by way of inserting falsified data into a fire detection sensor, which may bring about the unnecessary and costly evacuation of all personnel from an entire building.

To address these challenges, and potentially others, a blockchain or blockchain-like process can be used to authenticate various devices and/or transactions associated with a building services network. The authentication may be performed at any of various times and under conditions associated with the creation and operation of a building services network. Among these are (a) the onboarding process for building services network element, (b) the extension of services (e.g., activation of Wi-Fi or cellular service to a new building tenant) that employs building services network element, and (c) controlling network transactions such as transmission of particular sensed data values or video content from or among network elements. Each of these examples is discussed in a separate section below.

Device authentication may be viewed as a security mechanism designed to ensure that only authorized devices can connect to a given network, site, or service. In some implementations, device authentication includes embedding encryption keys within a secure platform and/or device hardware, such as processors. Since the security keys are linked to the device, the keys, in essence, become a piece of the hardware itself and are capable of providing authentication. As explained below, device authentication may also involve blockchain authentication. Services and network transmissions may similarly be authenticated via key-based and/or blockchain-based mechanisms.

In certain implementations described herein, a blockchain procedure is used to authenticate, authorize, validate, or otherwise approve a building services network element, service, and/or transaction. Features of blockchain approval include a peer-to-peer network of “peer” devices, in which individual devices operate independent from each other to determine whether to approve a particular device, service, or network transaction. Each peer device separately considers whether a presented device, service, or transaction meets a set of rules or other criteria for allowing the particular type of device, service, or transaction. Then, collectively, the peer devices decide whether allow the device, service, or transaction. In certain implementations, the peers make this collective decision by voting. The resulting decision is recorded as a new block in a ledger or in another shared repository of the decisions. In some implementations, blockchain logic runs on a TCP/IP or other reliable network protocol. A blockchain network layer may include multiple sublayers, such as a peer-to-peer sublayer, a rules sublayer, and/or a ledger or record sublayer.

One or more applications may run on top of a blockchain network layer. For example, an application layer may run a contracts application for building-specific contracts that rely on a blockchain protocol for evaluation, execution, and/or enforcement. For example, the application may establish wireless service for a new tenant of a building. In other examples, an application may involve authenticating newly installed network elements or devices, or may involve allowing communications between heterogeneous devices.

### Onboarding

Accordingly, it may be advantageous to ensure that data communications among elements of a building services network maintain high integrity under all operating conditions. In particular implementations, such integrity may be brought about by ensuring that elements of a building services network undergo an “onboarding” process, which may begin at or during manufacturing of building services network elements. Such onboarding, which may be applied during the manufacturing of sensors/detectors (e.g., illumination sensors, gas detection sensors such as carbon dioxide sensors, temperature/humidity sensors, movement sensors, fire detection sensors, intrusion detectors, glass-breakage detectors, and so forth), as well as the manufacturing of electrochromic window components (e.g., window controllers, user control panels, etc.), may represent an effective technique of securing elements of the building services network.

As the term is used herein, “onboarding” may be defined as a process of incorporating a device, such as a network element, into a building services network. The onboarding process may include any one or more underlying operations such as identifying and authenticating newly manufactured (or refurbished) devices. Such process may involve (a) registering the device by recording various attributes, such as its type (manufacturer, product ID, operating parameters, etc.), its communications network attribute(s) (e.g., MAC address), the device serial number, the device lot number, or any combination thereof, (b) incorporating a security key in the device itself, along with recording the key in a secure repository, (c) shipping the device to the site of building having a building services network in which the device will be installed, (d) installing the device in the building and in a manner that connects or couples the device to the building services network, (e) confirming that the device meets certain security criteria (e.g., authenticating the device), and/or (f) associating the location of the installed device with a network identifier, or otherwise commissioning the device, or any combination of these operations. Thus, for example, an onboarding process may include a manufacturing aspect, in which unique and/or device-specific encryption keys are identified and/or loaded into one or more protected memory locations of a computing or sensing element of a building services network. In response to loading of encryption keys into a computing or sensing element, the security key may be transmitted to a cloud-based key repository, which may function to store security keys of all building services network elements, regardless of type, manufacturer, etc. During operation of the building services network, stored security keys may be compared with security keys transmitted from network elements to ensure that only network elements fabricated and/or assembled by certified manufacturing entities are permitted to operate utilizing the building services network. Additionally, during operation of the building services network, the keys may be used to encapsulate a message in accordance with an encryption protocol.

Many different types of devices that ultimately serve as network elements may be authenticated during onboarding. Generally, this includes any device that can send and/or receive data and/or commands, any device that has a digital identity, and/or any device that can process data. Many examples are considered Internet-of-things (IoT) devices. Categories of devices that may be authenticated during onboarding include, e.g., sensing devices, computational devices, user interface devices, and power distribution devices. There are many examples of computational devices including devices for building decision making (e.g., window tinting, HVAC control, security system settings, and lighting levels), general purpose computing devices available for building occupants and/or building administrators, and communications devices for, e.g., switching/routing, Wi-Fi, cellular, Citizens Band, Bluetooth, etc. In some instances, complex devices, such as devices that include multiple data generating and/or data processing devices, may be authenticated during onboarding. An example of such device is a digital architectural element that may include multiple sensors, a user interface, communication elements such as antennas and radios, processor(s), or any combination thereof. Examples of digital architectural elements and other multi-device digital building elements are described in International Patent Application No. PCT/US19/38429, filed Jun. 21, 2019, and titled “SENSING AND COMMUNICATIONS UNIT FOR OPTICALLY SWITCHABLE WINDOW SYSTEMS,” which is incorporated herein by reference in its entirety. An onboarding process may vary dependent upon device capabilities and may include onboarding of various types of cameras, sensors, radars, Bluetooth low-energy (BLE) beacons, scanners, or the like. In implementations, any device that requires or utilizes an Internet, Intranet, Ethernet, or other type of network connection, may undergo an onboarding process.

In an installation aspect of an onboarding process, elements of a building services network may be placed at predetermined locations in accordance with a building floor plan, for example, in which a correspondence is established between a particular network element identification number and a specific location. During such installation, a building services network element may be configured to cooperate, for example, with one or more nearby network elements. For example, a movement sensor placed in a particular conference room may cooperate to determine that a large number, such as between 20 and 25 individuals, have entered the conference room. Accordingly, the movement sensor may inform a nearby HVAC controller that airflow, which may operate to provide cooling air to the conference room, should be increased so as to maintain a comfortable temperature of the conference room at all times. In an authentication aspect of an onboarding process, encryption keys of newly-installed elements of a building services network may be matched with security keys loaded into, for example, computing and/or sensing elements of a building services network to determine correspondence. In response to a determination that a security key of an installed computing and/or sensing element does not correspond to a security key stored in, for example, a repository that contains encryption keys from a certified manufacturing entity, an installer may identify the computing and/or sensing element as being potentially counterfeit and remove/uninstall the element from the building.

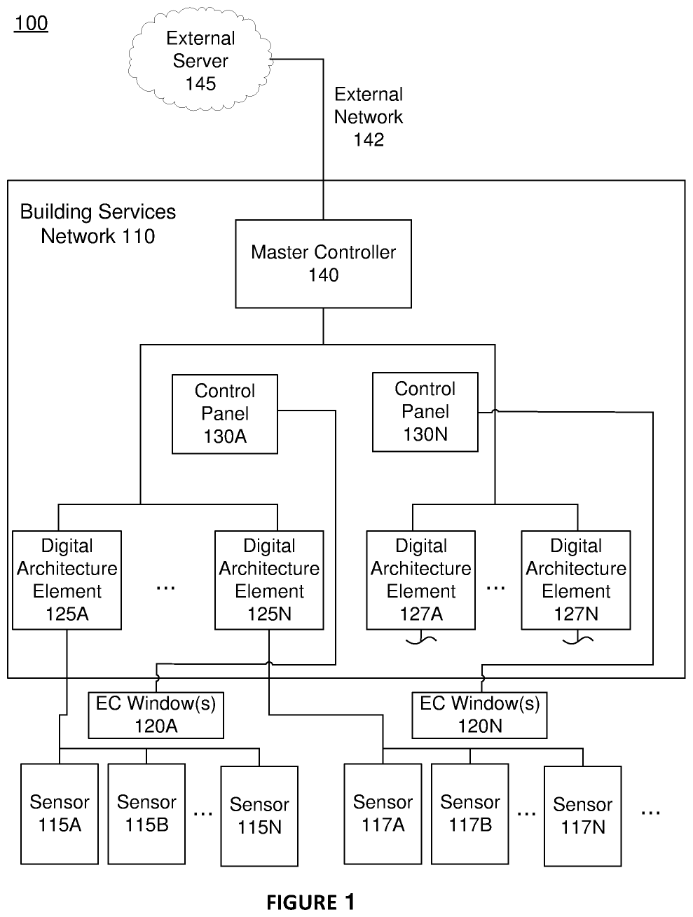

FIG. 1 depicts an architecture 100 of a building services network, according to an implementation. The network of FIG. 1 may operate to transmit control signals to network elements of the building services network as well as to receive status parameters pertaining to an in-building environment, perimeter security, movement of personnel within the building, and a wide variety of additional parameters. The disclosed and claimed subject matter is not limited in this respect. It should be noted that although building services network 110 of FIG. 1 is depicted as coupling to a single external network (e.g., external network 142) in particular implementations, building services network 110 may couple to additional networks, such as an enterprise voice/data communications network, an emergency services network, a power and/or lighting distribution network, an HVAC network, etc. Further, building services network 110 may represent only a single network of a group of building services networks that operate within a multistory building, for example, which may accommodate a number of enterprises. Accordingly, a multistory building may include any number of building services networks 110, each of which may provide services to a portion of the multistory building. In addition, although architecture 100 depicts elements of building services network 110 operating via a single type of communications medium, such as hardware interfaces, elements of a building services network may communicate via a mixture of hardwired or wireless connections, and claimed subject matter is not limited in this respect. In particular implementations, hardwired elements of building services network 110 may include one or more conductors compatible with a revision of the Multimedia over Coax Alliance (MoCA) consortium. Wireless elements of building services network 110 may include one or more Bluetooth, Wi-Fi, ZigBee, Z-Wave, Neul, Sigfox, LoRaWaN, and ultra-wideband (UWB) communication links.

Master controller 140 of building services network 110 may communicate with a plurality of network controllers, window controllers, or other elements, some of which may be housed within control panels, such as control panels 130A through 130N. In some implementations, a master controller (e.g., master controller 140) is housed within a control panel. In various implementations, master controller 140 is configured to provide control signals to, and receive measurements or other data (which may include commands) from, digital architecture elements 125A through 125N and digital architecture elements 127A through 127N. Additionally, master controller 140 may operate to communicate with electrochromic windows 120A through 120 via a control area network (CAN) bus compliant with a revision of ISO 11898-2. Thus, in the implementation of FIG. 1, control panel 130A may receive inputs from a user by way of an appropriate user interface to dim or tint one or more of electrochromic windows 120A. In response to receipt of signals from the user interface, control panels 130A-130N may provide appropriate time-varying voltage and/or current signals to one or more of electrochromic windows 120A-120N. Such voltage and/or current signals applied to electrochromic windows 120A-120N may bring about an increase or decrease in visible light permitted to pass through the electrochromic window. In particular implementations, such control of visible light permitted to pass through an electrochromic window may be manually controlled, such as via control panel 130A, or may be controlled without user input based on predetermined threshold settings. Thus, in particular implementations, a south-facing or west-facing electrochromic window may be automatically (e.g., without user input) configured, such as by way of selected applied voltage and/or current signals, to decrease visible transmittance during hotter, afternoon hours, while increasing visible light transmittance during cooler, morning hours. Additionally, in certain implementations, such automatic control over a tinting state of an electrochromic window may be overridden, for example, by way of a user interacting with an appropriate user interface of a control panel, such as control panel 130A. Further examples of electrochromic windows and attendant features and capabilities are provided in U.S. patent application Ser. No. 15/334,832, filed Oct. 26, 2016, and titled “CONTROLLERS FOR OPTICALLY-SWITCHABLE DEVICES” and International Patent Application No. PCT/US17/62634, filed on Nov. 23, 2016, and titled “AUTOMATED COMMISSIONING OF CONTROLLERS IN A WINDOW NETWORK,” both of which are herein incorporated by reference in their entirety.

Building services network 110 additionally includes sensors 115A, 115B, . . . 115N, which operate under the control of digital architecture element 125A. As previously alluded to, sensors 115A through 115N and sensors 117A, 117B, . . . 117N may include a variety of sensor and/or detector types, such as temperature and/or humidity sensors, ambient light sensors, gas sensors such as volatile organic compound (VOC) sensors and carbon dioxide/carbon monoxide sensors, seismic sensors, movement detectors, glass-breakage detectors, and the like.

Accordingly, in view of the wide variety of sensing/detection functions performed by sensors 115A through 115N and sensors 117A through 117N, it may be advantageous to safeguard the integrity of communications traffic among network elements of building services network 110. Thus, in certain implementations, all network elements of building services network 110 may undergo an onboarding process, such as during manufacturing and installation of network elements, so as to provide adequate protections against falsified communications traffic, which may be maliciously inserted into one or more communications links between network elements. Such malicious insertion of falsified data traffic into building services network 110 can have far-reaching implications. Such implications can range from the relatively benign failure of an electrochromic window to adequately modify transmittance of visible light during a hot afternoon, to a relatively significant failure to notify emergency personnel of a fire, an increased level of carbon monoxide, or other safety-related condition within a building.

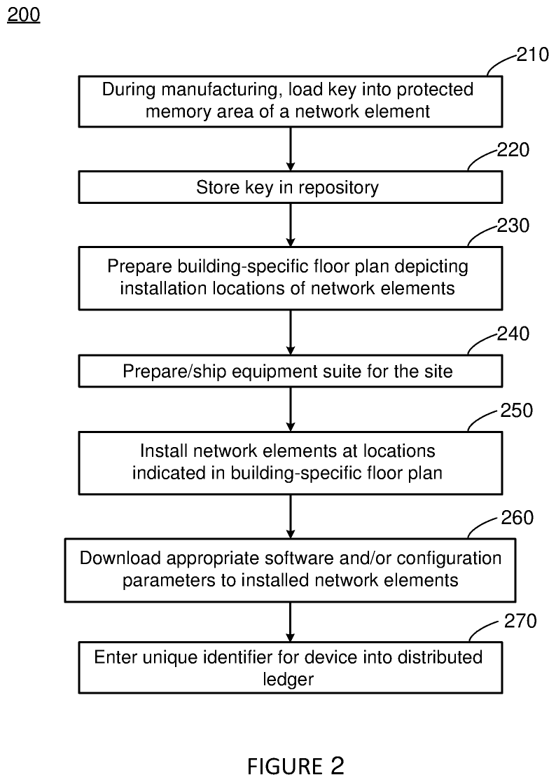

With this in mind, FIG. 2 is a flowchart 200 for a method of onboarding an element of the building services network, according to an implementation. It should be pointed out that the operations and methods shown and described herein may not necessarily be performed in the order indicated in FIG. 2 and in other figures throughout this disclosure. It should also be noted that the methods may include more or fewer operations than those indicated. In some implementations, operations described as separate operations may be combined to form a smaller number of operations. Conversely, what may be described herein as being implemented in a single operation may be alternatively implemented by way of multiple operations.

The method of FIG. 2 may begin at 210, in which, during the manufacturing process, one or more encryption keys are loaded into a protected memory area of a network element. A protected memory area may include one or more memory addresses accessible only to specialized equipment, such as equipment used in a manufacturing environment, rather than a memory address accessible to a processor of the network element. Alternatively, a protected memory area may include one or more memory addresses accessible to a processor of the network element while the processor executes a program whose operation is enabled exclusively during a manufacturing process. A security key entered into a network element at 210 may include any appropriate security key, such as a key generated in accordance with an encryption standard such as the Advanced Encryption Standard (AES) or the Data Encryption Standard (DES) or a Rivest, Shamir, Aldeman (RSA) cryptosystem. In particular implementations, a security key for a network element may be derived, such as by utilizing a hashing algorithm, from a serial number of a network element, a universal unique identifier (UUID) of a processor of a network element, or utilizing any other device-specific number or parameter.

It should be noted that 210 may involve the loading of a number of security keys into network elements, which may be utilized for differing operations of network elements. For example, in certain implementations, a radar-based in-building movement sensor, which may operate to track the movements of building occupants, may be capable of data collection to identify certain individuals according to an individual's unique gait, physical size, and so forth. Thus, in such implementations, a first security key may be utilized to safeguard the integrity of all communications traffic emanating from the movement sensor, while a second security key may be utilized to provide additional safeguards to prevent the unauthorized access to parameters extracted from movement sensors. Such parameters could be used to obtain sensitive information concerning confidential visits by high-profile executives, for example, whose identity should be restricted to small groups of individuals.

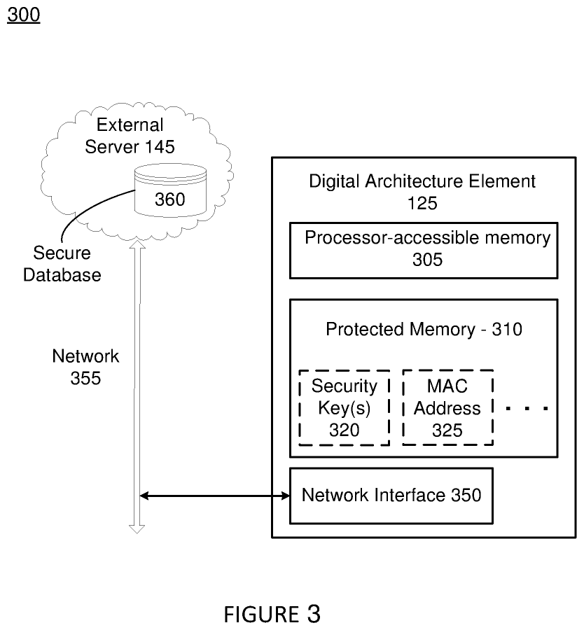

At 220, before, during, or after a security key being loaded into a protected area of memory of the network element, the security key may be stored in a key repository, such as a secure database at a location accessible via an external network such as the Internet. In implementations, certain credentialed contract manufacturers, partners, suppliers, or the like may gain access to the key repository. A secure database utilized at 220 may store security keys from multiple manufacturers of network elements, such as manufacturers of digital architecture elements 125A through 125N described in reference to FIG. 1, as well as manufacturers of other types of sensors, such as sensors 115A through 115N also described in reference to FIG. 1. Accordingly, in certain implementations, a secure database may operate as a repository for storage of keys of a wide variety of network elements of a building services network, such as security keys from temperature/humidity sensors, gas sensors (e.g., sensors for VOCs, carbon dioxide, carbon monoxide, etc.), illumination sensors, perimeter security sensors, glass breakage detectors, seismic sensors, and so forth, virtually without limitation. A network element showing security key storage in a protected area of memory, as well as storage of security keys in a secure database is described greater in detail with reference to FIG. 3, herein.

At 230, a building-specific floor plan may be generated to depict locations at which particular network elements are to be placed. 230 may involve determining optimal or appropriate locations within a building for the placement of illumination sensors, temperature/humidity sensors, seismic sensors, perimeter sensors, and so forth. It is contemplated that 230 may involve the utilization of a range of building-specific information, such as the orientation of the various windows of a building, locations and dimensions of conference rooms, hallways, lobbies, foyers, restrooms, and so forth. 230 may involve utilization of various structural details of a building, such as locations of elevator shafts, staircases, fire doors, and so forth. Accordingly, preparation of a building-specific floor plan may result in a customized layout, depicting locations of electrochromic windows, digital architectural elements, control panels, sensors, and/or detectors, which may be tailored according to the particular requirements of each enterprise or type of enterprise scheduled to occupy a particular building. The floor plan may be provided as part of an architectural drawing, interconnect drawing, or the like. In certain implementations, building-specific floor plans are generated using methods and/or tools as described in PCT Patent Application No. PCT/US17/62634, filed Nov. 20, 2017, which is incorporated herein by reference in its entirety.

At 240, following the preparation of a building-specific floor plan, an equipment suite may be assembled and shipped to a site. It is contemplated that at least in certain implementations, the assembled equipment suite may include dozens, hundreds, or even thousands of network elements, all of which may include one or more security keys loaded into protected memory areas. Security keys loaded into protected memory areas may also be stored in a secure database accessible via the Internet. In certain implementations, at least some of the equipment (devices) in the suite does not have processors. Nevertheless, such devices may introduce security-related concerns and therefore their locations are mapped in the floorplan. At 250, one or more installers may install network elements at locations indicated in the building-specific floor plan prepared or generated at 230. In certain implementations, in response to consulting the building-specific floor plan, an installer team may install prescribed equipment, such as sensors, detectors, digital architecture elements, control panels, and master controllers, at locations specified in the building-specific floor plan. Following installation of network elements, an installer may establish a communications link between a computing device utilized to assist in installation of network elements. After establishing the communications link, an installer may configure the network element, which may include providing location parameters to the network element, such as by identifying a cardinal direction (e.g., North, South, East, West) faced by a window under the control of, for example, control panel 130A.

Following installation procedures, transmissions from the network element may include a preamble, which may include a security key, or a code derived from a security key, which may thus provide an identification of the transmitting network element to one or more receiving network elements.

At 260, an installer may provide parameters to an Internet-based or cloud-based provisioning database, which may operate to provide provisioning software and/or other equipment settings dependent upon a unique identifier of a network element. For example, in certain implementations, a network element may include a bar code and/or an RFID tag, which may be read by an installer and uploaded to the provisioning database. In response to the provisioning database determining the network element type (e.g., temperature sensor, humidity sensor, carbon dioxide sensor, or fire detection sensor), the provisioning database may select software and/or configuration settings for download to the network element. Also at 260, an installer may provision a network element with software and/or other communication parameters, which may permit the network element to communicate with other network elements of the building services network. Thus, in certain implementations, an installer may provide address parameters (such as Internet protocol addresses) and/or other settings, such as port identifiers, which may permit messages transmitted from the installed network element to be recognized as being authentic by other elements of the building services network. 260 may additionally include an installer downloading to a network element, communication settings that may assist the network element in communicating with nearby network elements or network elements utilized to serve the immediate area. For example, in particular implementations, an installer may download to a network element, such as a temperature sensor or a humidity sensor, communication settings so as to permit the temperature sensor to communicate with a component of an HVAC system. Such communication settings may permit the temperature sensor to request increased airflow at a corresponding location in response to measurement of an increasing temperature by the temperature sensor.
1) At 270, following the downloading of appropriate software and/or configuration parameters, if any, an installer may publish identifying parameters, such as Internet protocol address, port identifier, and so forth, to a distributed ledger. In certain implementations, such ledger does not include security keys and is not linked to a repository of such keys such as one described with reference to operation 220. In certain implementations, a distributed ledger provides information about specific network elements that permits other network elements of the building services network to recognize transmissions from installed network elements as being authentic. In certain implementations, a distributed ledger includes one or more unique addresses, such as a media access control (MAC) address, a universal unique identifier (UUID), for example. Accordingly, network elements of the building services network that participate in the distributed ledger may be utilized to validate and/or authenticate data transmitted by other network elements based on ledger information about the network elements of the building services network.

Validation and/or authentication of devices may involve generation of distributed ledger entries by way of a blockchain procedure, in which an addition of a network element to the building services network may be viewed as a blockchain “transaction.” Specifically, blockchain techniques may be employed to approve addition of a network element by, for example, authenticating a code, which may represent identification parameters transmitted by a network element to be added to the network. Validation and/or authentication of the network element may be performed by a peer group, which may be made up of peers from entirely within the enterprise deploying or owning the building services network, of peers from entirely outside of the enterprise, or of peers from both within and outside of the enterprise. In certain implementations, the peer group is made up of a subgroup of network elements previously added to the building services network.

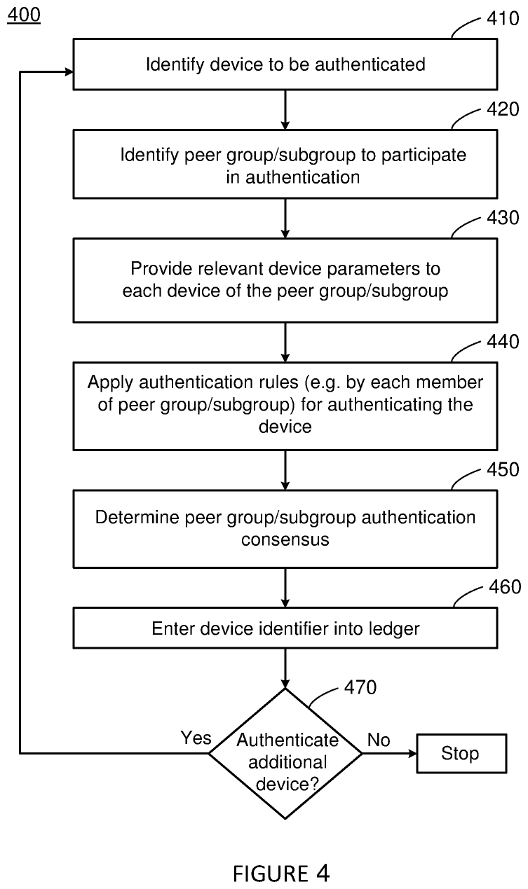

In some implementations, a blockchain peer group involved in an authentication includes network elements that perform similar functions. For example, blockchain-based validation and/or authentication of a temperature sensor may employ a peer group that includes one or more previously validated temperature sensors. In other implementations, a peer group involved in the authentication of network elements may include network elements of a building services network dedicated or assigned to a particular building tenant. In other implementations, a peer group may include network elements of a building services network dedicated or assigned to a particular enterprise housed within a building. In other implementations, a peer group may include network elements of a particular floor of a multistory building. FIG. 4, described herein, includes additional details of possible authentication processes, which may be performed in addition to those described in reference to FIG. 2.

In particular implementations, at least during initial stages of equipment installation of a building services network, a distributed ledger may be held by a small number (e.g. between 2 and 5) computing devices. For example, at an initial stage of equipment installation, a first distributed ledger may be held in a database accessible by a computing device utilized to download provisioning software and/or other equipment settings of network elements. A second distributed ledger may be held in a database accessible by a computing device utilized to perform calibration processes, which may involve optimization of equipment settings in real-world (installed) environments. A third distributed ledger may be held in a database accessible by a computing device that operates to obtain performance information from network elements during burn-in or other reliability testing operations. In certain implementations, any such distributed ledger is produced and updated using a blockchain procedure.

FIG. 3 is a diagram of a network element showing processor-accessible and protected memory areas for storage of security keys, according to an implementation 300. As described in reference to FIG. 2, such as at 210 and/or 220, during the manufacturing process, one or more security keys may be loaded into a protected memory area of a network element (at 210), and the security keys may be stored in a key repository, such as a secure database (at 220). Thus, FIG. 3 shows digital architecture element 125 comprising at least two types of memory coupled to a processor (not shown in FIG. 3). A first memory may include processor-accessible memory 305, which may be responsible for storing instructions executable by a processor as well as storing results of such processing. Processor-accessible memory may include random access memory, read-only memory, disk-based memory, or any other type of memory, and claimed subject matter is not limited in this respect. A second memory coupled to a processor of digital architecture element 125 may additionally include protected memory 310, which correspond to memory addresses or locations that are not accessible to a processor of element 125, except when the processor executes instructions enabled or at least initiated exclusively during a manufacturing process. Alternatively, a protected memory 310 may represent memory addresses or locations accessible only by specialized manufacturing equipment.

Protected memory 310 may represent nonvolatile memory, which may retain one or more of security keys 320 and/or media access control (MAC) address 325 after removal of primary power to digital architecture element 125. Thus, security key(s) 320 as well as MAC address 325 may represent parameters that are permanently retained within protected memory 310. In certain implementations, following storage of security key(s) within protected memory 310, network interface 350 may communicate with network 355 to permit uploading of the stored security key(s) to a cloud-based external server (e.g., external server 145) for storage within secure database 360. In response to storage of one or more security key(s) 320 and/or MAC address 325, these parameters may be available for use during subsequent installation and device authentication.

FIG. 4 is a flowchart for a method 400 of authenticating an element of a building services network using a blockchain procedure that produces a ledger distributed among a peer group, according to an implementation. The method of FIG. 4 may be applied to any network element used in a building services network, such as sensors/detectors (e.g., illumination sensors, carbon dioxide sensors, temperature/humidity sensors, movement sensors, fire detection sensors, intrusion detectors, glass-breakage detectors, and so forth), as well as to electrochromic window components (e.g., window controllers, user control panels, etc.), as well as to a wide variety of other network elements of a building services network. Although it is contemplated that the method of FIG. 4 may be invoked or initiated by one or more installers during installation of network elements according to a floor plan prepared for a specific building or structure, in particular implementations, the method of FIG. 4 may be initiated at other times.

At 410, a device to be authenticated may be identified. In certain implementations, identification of such devices may occur during actual installation of, for example, a digital architecture element, which may be positioned on or within a mullion of a building. In other implementations, such as those involving installation of individual sensors as network elements, a device to be authenticated may correspond to a temperature/humidity sensor, which may be installed above an overhead ceiling panel in a hallway of a building. Regardless of the type of device to be authenticated and its location within a building, at 420, a peer group may be identified that will take part in an authentication process for a device identified at 410. In particular implementations, a peer group of the device may correspond to a group or subgroup of similar devices performing a similar function within a building services network. For example, if a device to be authenticated corresponds to a carbon dioxide sensor, an identified peer group may include other carbon dioxide sensors, which may have been previously installed and authenticated in a particular building. In other implementations, a peer group at of the device to be authenticated corresponds to network elements located at one or more portions of a building, such as a floor or story of a multistory building, leased by a particular company or organization. In other implementations, a device may be authenticated by all or virtually all of the network elements of a building services network, such as master controllers, control panels, digital architecture elements, and so forth. In another implementation, a peer group utilized to authenticate a network element may include computing devices previously utilized to perform manufacturing processes, calibration processes, and/or burn-in or other reliability testing operations.

As mentioned, in particular implementations, peers may be selected from within or outside of the enterprise responsible for the building or the building services network. In instances in which a blockchain type authentication is performed during manufacturing or installation of a device, the peers may, of necessity, be drawn from outside of the enterprise. In particular implementations, use of peers drawn from outside of the enterprise may be due to a sufficient number of peers being not yet available within the enterprise. In certain implementations formation of a peer group may be at least partially based on device roles of network elements, such as formation of a peer group of security-related devices (e.g., perimeter sensors, intrusion sensors, etc.,) formation of a peer group of comfort-related devices (e.g., temperature/humidity sensors, etc.,), or formation of a peer group at least partially based on other common roles or characteristics of devices. In certain instances, a peer group may be formed from devices outside of a building, such as master controllers from adjacent buildings, or buildings in other regions, that may be constructed by the same or a similar building contractor or that may be under the control of the same corporate entity, for example.

At 430, relevant authentication rules, such as particular device parameters may be provided to each member of a peer group, which may enable the peer group to authenticate the device. In certain implementations, such relevant device information may include parameters such as ranges of permissible device MAC addresses, potential ranges of device serial numbers, firmware identifiers, an identifier to indicate possible manufacturers of the device, a universal unique identifier (UUID) of a processor utilized in the device to be authenticated, and/or other parameters. Such parameters may permit devices within a peer group to detect whether a device to be authenticated is a counterfeit device or, at minimum, a device that has not undergone appropriate manufacturing and/or validation processes.

In some implementations, one or more of the peers of a peer group charged with making authentication decisions is in possession of all required information (e.g., device parameters and/or other information required to apply authentication rules) available to make the authentication decision. Such information may be available from configuration files, floor plans, available ledgers, and the like. In other instances, devices to be authenticated may provide some or all of the information required by peers. To this end, at 440, in response to one or more queries from a device to be authenticated, the device to be authenticated may transmit relevant parameters, which may be received by members of the authenticating peer group. Also at 440, the authenticating group may apply various authentication rules to assist in determining whether the device can be authenticated. Accordingly, each member of the authenticating group/subgroup may determine if a received serial number is within an acceptable range of serial numbers, for example.

Alternatively, or in addition to, each member of the authenticating group may determine if a firmware revision is greater than a threshold value. Alternatively, or in addition to, each member of the authenticating group may determine if a received MAC address is within an expected range. Members of an authenticating group may apply additional rules and/or policies in response to obtaining parameters of a device to be authenticated. In certain implementations, authentication may be brought about by way of computational elements of a peer group computing or “mining” to provide a hash value that meets criteria so that a ledger block can be appended to an existing ledger blockchain. In response to an application of rules and/or policies by members of an authenticating group, a consensus may be determined as to whether the device can be authenticated, such as at 450. In particular implementations, a consensus may include 51% of the members of the authenticating group. In other implementations, a consensus may include a different percentage of members of an authenticating group, such as 55%, 60%, 75%, and so forth. At 460, identifying parameters, such as a MAC address, port identifier, etc., may be entered into a ledger of authenticated network elements.

The method may continue at 470, in which an additional device to be authenticated may be identified. The additional device to be authenticated may correspond to a different device to be manufactured by a manufacturer or installed by an installer. As explained, examples of such devices include a digital architecture element, temperature/humidity sensor, etc. If additional devices are to be authenticated, control may return to 410. If no further devices are to be authenticated, the method may come to a stop.

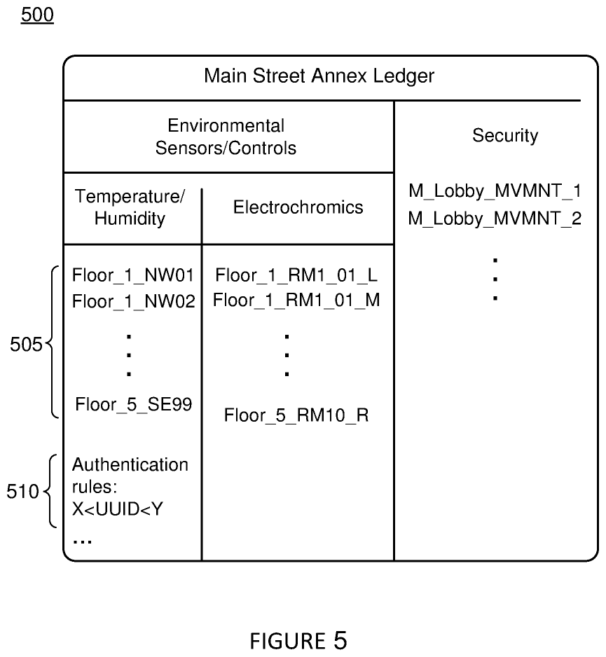

FIG. 5 shows a sample site-level ledger 500 for elements of a building services network, according to an implementation. Ledger 500 may correspond to a ledger for an entire building or site, such as the “Main Street Annex,” which may correspond to a multi-tenant commercial building having at least 5 stories. In FIG. 5, the ledger is divided into smaller groups of network elements, such as ledger groups pertaining to environmental sensors/controls, such as temperature/humidity sensors, sensors and controls pertaining to electrochromic windows, security elements, and so forth. It should be noted that although site-ledger 500 appears to indicate only a small number of ledger groups and subgroups, in other implementations, a site-level ledger may include a large number of groups, such as environmental sensors/controls, security, occupational health & safety, HVAC, power systems, elevators, lighting systems, and so forth. Additionally, within a group of network elements, such as a group related to security aspects of a building services network, a wide variety of subgroups may exist, such as subgroups pertaining to glass breakage sensors and detectors, movement sensors, unauthorized entry sensors, etc. Further, each entry of site-ledger 500, such as Floor_1_NW01, Floor_1_NW02, and so forth, may be accompanied by individual equipment parameters, such as serial numbers, MAC addresses, processor UUID values, firmware revision identifiers, and so forth. A ledger such as site-ledger 500 may be generated during a blockchain, peer-based authentication procedure such as that shown in FIG. 4.

In particular implementations, the site-level ledger containing some or all information of ledger 500 of FIG. 5 may be utilized to authenticate devices being added to a building services network. Accordingly, as an example, in response to an installer installing a temperature/sensor at the 6^{th} floor of the Main Street Annex (e.g., labeled Floor_6_NW01), each temperature sensor of subgroup 505 (Floor_1_NW01 through Floor_5_SE99) may be queried to determine if a consensus exists as to whether the temperature/humidity sensor labeled Floor_6_NW01 can be authenticated. During a querying process, the temperature/humidity sensor labeled Floor_6_NW01 may be requested to transmit credentials to each temperature/humidity sensor of subgroup 505. Additionally, each temperature/humidity sensor of subgroup 505 may be preloaded with authentication criteria, such as acceptable UUID values (e.g., X<UUID<Y) which enable each temperature/humidity sensor of subgroup 505 to ascertain whether sensor labeled Floor_6_NW01 represents an authentic device or a counterfeit device. It should be noted that although authentication rules 510 shown in FIG. 5 indicate only a single rule (X<UUID<Y), in certain implementations a number of authentication rules may be utilized, such as those described in reference to 430 of FIG. 4.

### Building Services Activation

In certain implementations, a blockchain procedure is used to review requests for building service activation. In particular implementations, such a review process can be conducted to determine if a new service can be introduced via the building services network or if an existing service provided by the building services network can be upgraded. It is contemplated that at least in some implementations, a review process may be conducted once prior to service activation without a need for additional review processes. Accordingly, authenticating activation of a service may correspond to a contractual evaluation, such as in response to a building tenant providing compensation for a service for a specified duration (e.g., monthly, yearly, or other defined term). It should be pointed out, however, that authenticating network communications may be employed to enforce terms of a service contract.

In particular implementations, a review process may be brought about utilizing an electronic ledger distributed among a peer group of computing elements that collectively ensure compliance with an agreement, which may be a long-duration or a short-duration service agreement. Such an approach may be employed for various purposes related to building service activation. For example, a blockchain procedure may be employed for the purpose of determining whether to extend building services to particular tenants or other building occupants, and optionally determining and/or applying particular terms and conditions of such services. In some cases, a blockchain procedure is used to confirm activation of a wireless communication service for a particular tenant or for a particular region of a building. Among the wireless communications services that may be activated in this manner is Wi-Fi, cellular, Bluetooth, Citizens Broadband Radio Service band (e.g., 3.5 GHz), Family Radio Services band (462 MHz/467 MHz) and the like. In one example, a blockchain procedure is used to evaluate or execute an agreement to provide a videoconferencing session between two conference rooms coupled to a building services network. In such implementations, a peer group of computing elements may be utilized to determine, such as via a consensus among network elements of the peer group, if such a session is in accordance with an overarching building services agreement. After the blockchain procedure authorizes the session, it may be allowed to proceed without further review. In some applications, a blockchain procedure is employed to determine a level of service such as a maximum latency, a level of security, or other quality-of-service metric associated with a particular service (e.g., access to the internet or to a cloud-based service). In some applications, a blockchain procedure review can determine a subset of network elements, a routing path, a communications protocol, or other aspect of a service that involves transmitting data from point A to point B. For example, the process can determine whether the activated service must route particular data traffic (e.g., building-related data) via an internal building network to an enterprise data lake or via a cellular service to a cellular carrier data lake. In some cases, the service pertains to generating reports or compliance information such as reports relating to levels of particular gases or contaminants in a region of a building. In some instances, compliance information may be generated in response to a threshold number of people occupying a building or a portion of a building. In other instances compliance information may be generated in response to a particular density of people in a building or in a region of a building. In other instances compliance information may be generated at certain times during a workday, for example, or during certain days of a workweek.

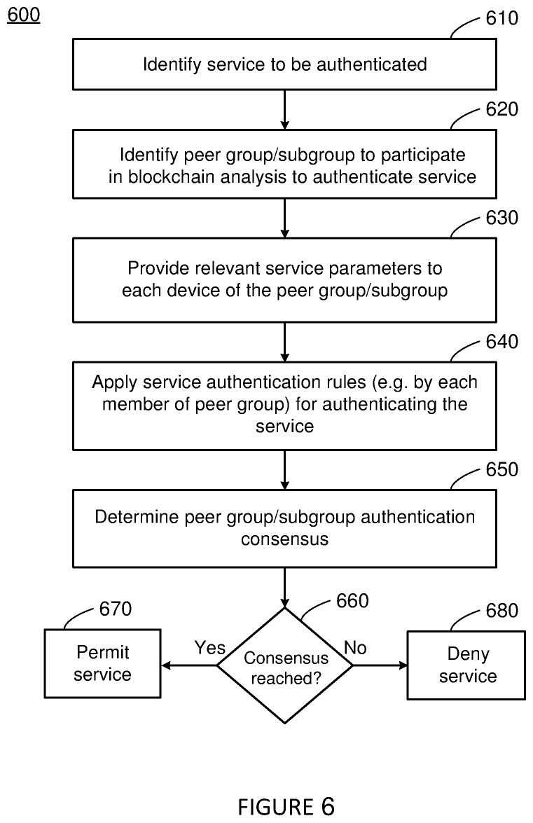

FIG. 6 is a flowchart 600 for an example method of authenticating a service to be performed by a building services network, according to an implementation. The method may begin at 610, which may include identifying a service to be authenticated. 610 may be performed in response to a request for a service, such as video conferencing between or among conference rooms, Wi-Fi services, Bluetooth capabilities, cellular telephone communications, and so forth. In other implementations, a requested service may pertain to sensor data collection and/or sensor data transmission to network elements of the building services network or may pertain to data transmission to computing entities located outside of the building services network. For example, a requested service of a building services network may pertain to redirection of measured carbon dioxide levels, or to any other environmental parameter, which can be collected at various locations within a building. Such environmental parameters may be redirected from within a building services network so as to be transmitted to a citywide data-gathering service to ensure compliance with local environmental health and safety standards. However, prior to such data-gathering and/or transmission to a data collection service, it may be advantageous to seek approval for redirection from a peer group of network elements.

Thus, the method may continue at 620, in which a peer group is identified to take part in an authentication process for a service, or upgrade to an existing service, identified at 610. In certain implementations consensus among a peer group may be obtained via a blockchain-based technique to authenticate or validate a transaction that represents a new service or an upgrade to the existing service. Accordingly, a peer group of a device or family of devices involved in providing a new service or upgrade to an existing service may correspond to a group or subgroup of similar devices performing one or more similar functions within a building services network. For example, if authentication of a transaction representing a new service/service upgrade corresponds to videoconferencing among two or more conference rooms, network elements performing videoconferencing functions may form a peer group to authenticate the new service and/or an upgrade to an existing videoconferencing capability. In another example, a peer group involved in authenticating a transaction may correspond to network elements assigned to a particular tenant or to a particular business enterprise within a building. In another example, a peer group may correspond to network elements of a particular floor, or a particular group of floors, of a multistory building. In certain implementations, network elements of a peer group may correspond to network elements previously authenticated via a process similar to that described in reference to FIG. 4. In certain implementations, all members of a peer group are owned or controlled by a single enterprise. In certain implementations, all members of a peer group are located within a building for which the service in question is being evaluated.

At 630, relevant service parameters for evaluating rules for activating a service may be provided to each device of a peer group formed at 620. Relevant service parameters may correspond to any pertinent information to define a requested service or a requested upgrade to a service. Thus, for example, if a videoconferencing service capability is requested, relevant service parameters may include an identification of the rooms or areas of the building that are to participate in videoconferencing, computing and/or network resources involved in conveying audio/video information, a duration of the videoconference, whether video data is to be rendered in high definition or standard definition, and so forth. In another example, such as data-gathering and transmission of environmental parameters collected by carbon dioxide sensors, relevant service parameters may correspond to the rooms or regions of a building at which carbon dioxide parameters are to be gathered, duration of such data collection, data sampling rates, designated recipients of collected carbon dioxide parameters, and so forth.

The method may continue at 640, at which service authentication rules may be applied by each member of a peer group. In particular implementations, applying authentication rules may involve performing comparisons of a requested capability with terms and conditions of a service contract. Thus, for example, if a service contract for an enterprise were to specify a maximum of 20 hours of videoconferencing per month, service authentication rules may involve comparing a requested duration of the videoconference with an aggregate of previous videoconferencing durations for a given month to determine if the specified maximum has already been met. In another example, a peer group may determine if a requester of carbon dioxide or other environment-related information meets specified qualifications as having a genuine need-to-know such information. In another example, a peer group may determine if a customer of a cellular telephone carrier can avoid voice/data bottlenecks created by a potentially congested building services network. In such an instance, an upgrade to a quality of service contract may involve decreased network latency via bypassing certain nodes of a building services network in favor of a more direct connection between a cellular telephone customer and an external cellular communication system.

At 650, network elements of a peer group may participate in arriving at a consensus as to whether a new service or upgrade to existing service should be approved based on relevant service parameters provided to members of the peer group at 630 as well as application of service authentication rules by each member of a peer group at 640. In implementations, if it is determined that a majority of network elements of a peer group approve of the service, such as at 660, transaction approval may be documented via an appending of a distributed ledger. Thus, at 670, the requested service, or upgrade to existing service, may be permitted. Conversely, if the decision at 660 indicates that a consensus has not been reached, the service may be denied, such as at 680.

In particular implementations, activation of a new service, or an upgrade to an existing service, may involve analytics utilizing or derived from measurements performed or collected by sensors of the building services network. For example, data collection from one or more temperature sensors of a building may be utilized to indicate an amount of savings realized by minimally increasing the temperature (such as during the summer months) or decreasing the temperature (such as during winter months) of a room. Such information may be useful to a local public utility company seeking to provide information that may assist other customers in realizing similar savings. In another example, information from a group of carbon dioxide sensors may be transmitted to a health and safety monitoring service, which may communicate with a building HVAC system to ensure that carbon dioxide levels do not exceed threshold levels. In particular implementations, such monitoring may be combined with data gathered from radar, infrared, and/or movement sensors which may operate to proactively increased airflow in a portion of a building so as to maintain healthy carbon dioxide levels at all times. Accordingly, in such scenarios, a new service or upgrade to an existing service may include access to algorithms and/or analytics. Whether access to such analytics/algorithms is to be granted may represent a transaction to be approved by a peer group.

Thus, at least in particular implementations, rules that can be applied to network elements of a building services network may include preventing or at least curtailing transmission of raw sensor data in favor of performing analytics on such data so as to provide potentially more meaningful parameters. Thus, for example, rather than providing raw temperature/humidity measurements at one-minute intervals, use of analytics and/or data abstraction algorithms may provide trending data, minimum/maximum data, or data relevant to whether a temperature/humidity has reached upper or lower threshold levels, and so forth. In other implementations, analytics and/or data abstraction algorithms may be applied to raw sensor data so as to format parameters into standard data structures perhaps to allow collection of sensor parameters by external (e.g., government) environmental health and safety monitoring organizations, standards bodies, and/or certification entities.

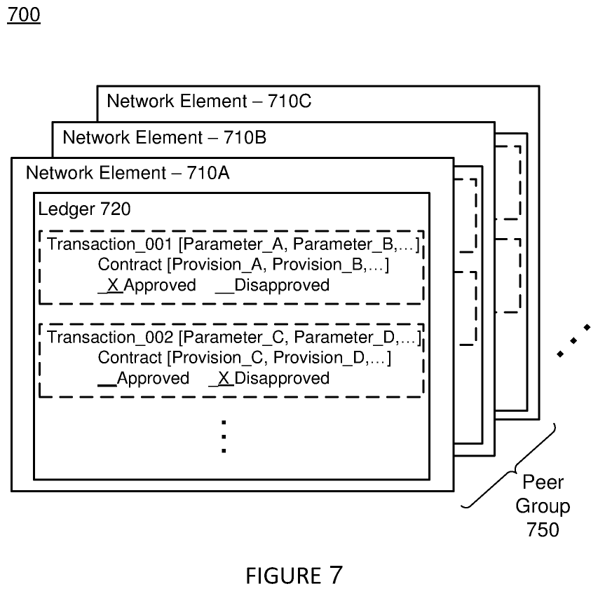

FIG. 7 is a diagram showing a peer group of network elements, in which each network element is indicated as storing a copy of a distributed ledger, according to an implementation 700. In FIG. 7, peer group 750 can represent any appropriate number of network elements. For example, peer group 750 may represent three network elements (710A, 710B, and 710C) or, perhaps, a larger number of network elements, such as 5 network elements, 10 network elements, 50 network elements, or an even larger number. Further, peer group 750 may represent network elements that may perform one or more similar building functions, such as building security operations, environmental/air-quality sensing, audio/video conferencing, temperature/humidity sensing, movement sensing, or any other function within a building services network. Alternatively, peer group 750 may represent network elements assigned to a particular enterprise, network elements of one or more floors of a multi-story building, or may represent any other appropriate grouping of network elements such as determined in accordance with 620 of FIG. 6.

Network element 710A is shown as storing ledger 720, which may include a record of transactions that have been evaluated by the network element. For example, network element 710A has previously participated in arriving at a consensus for transaction_001. Transaction_001 may represent any transaction, such as a determination of whether a particular service, or an upgrade to an existing service, should be approved by peer group 750. As described in reference to 630 of FIG. 6, parameter_A and parameter_B of ledger 720 may include a listing of relevant service parameters conveyed to network elements 710A, 710B, and 710C. Ledger 720 may additionally include a listing of contract provisions, such as provision_A and provision_B, as well as an indication as to whether network element 710A has approved each transaction. Accordingly, for the case of transaction_001, ledger 720 may indicate that network element 710A has approved the transaction. However, with respect to transaction_002, defined by relevant parameters C and D and in accordance with contract provisions C and D, ledger 720 indicates that the transaction has been disapproved.

Network elements 710B, 710C, may include similar, counterpart ledgers that correspond to ledger 720, each of which may list of transaction_001, transaction_002, and so forth, along with relevant parameters (e.g., parameter_A, parameter_B, and so forth) as well as contract provisions (e.g., provision_A, provision_B, and so forth). However, although ledger 720 of network elements 710A indicates approval and disapproval of particular transactions, network elements 710B and 710C may indicate differing approvals and disapprovals in accordance with each network element's determination of compliance of a transaction with one or more defined criteria pertaining to authentication of the service.

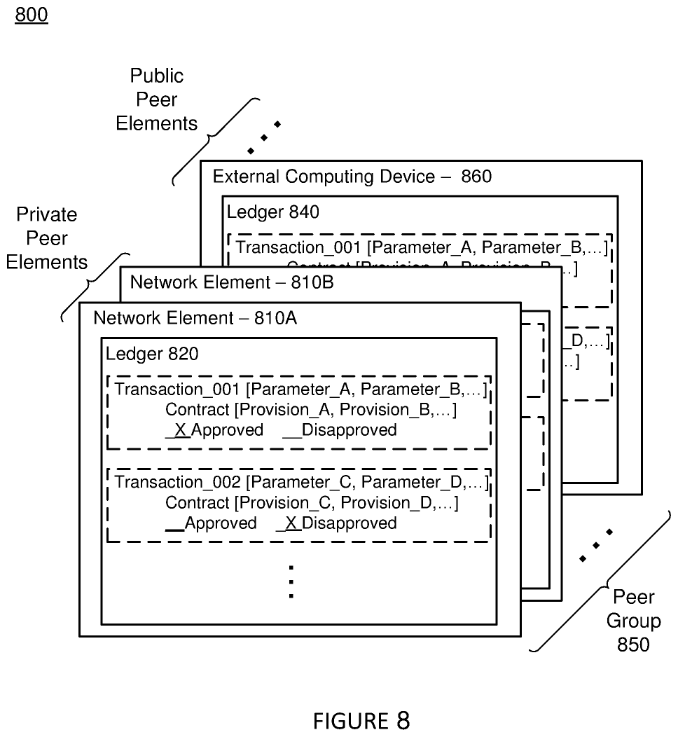

In particular implementations, approval of a transaction utilizing a blockchain procedure may involve a peer group that includes network elements of a building services network as well as computing elements external to the building services network. With this in mind, FIG. 8 (implementation 800) is a diagram showing a peer group of network elements 810A and 810B, which represent elements of a building services network, while external computing device 860 represents one or more computing devices external to the building services network. Network element 810 holds ledger 820 and external computing device 860 holds ledger 840. Thus, a transaction, which may involve a new service and/or an upgrade to an existing service, may be subject to approval by a consensus formed from a combination of in-building peers as well as peer elements drawn from computing resources external to a building services network. In certain implementations, external computing devices 860 may include network elements of other building services networks, such as building services networks in adjacent or neighboring buildings. In other implementations, external computing devices 860 may include specialized computing devices, such as components of a cellular communications infrastructure, components of government-operated environmental health and safety data collection computing resources, external building security services providers, utility companies, and so forth. In certain implementations, inclusion of diverse computing devices 860 into peer group 850 may serve to normalize or calibrate consensus-based decisions.

### Network Communications

While some implementations described above employ blockchain or blockchain-like procedures to perform a one-time authentication of devices during onboarding to a building services network and to authenticate activation or extension of services employing a building services network, blockchain procedures may be employed to authenticate other aspects or transactions of a building services network. For example, blockchain may be performed more regularly or even continuously to authenticate specific, individual network transmissions, such as transmissions of data and/or instructions, at the data, packet, or message level to evaluate individual communications for compliance with one or more defined criteria pertaining to authentication of the communication. Additionally, although authentication criteria for network communications may be based on service contract terms, such authentication criteria such authentication criteria are not themselves responsible for setting contract terms.

Examples of types of network transmissions that may be authenticated include instructions to devices (e.g., window tint instructions), video frames (or periodic samples thereof), sensor readings (or periodic samples thereof), security settings, user and/or enterprise privacy settings, and so forth. The network transmissions that may be authenticated using blockchain procedures may be based on the particular devices responsible for sending data or instructions. For example, all communications originating from a particular sensor (or group of sensors) may be subject to blockchain authentication. In another example, all communications from a particular device or group of devices that are addressed to a particular destination may be subject to blockchain-based authentication. As an example, the destination may include all destinations outside the building or building services network. As another example, the destination may include certain types of devices in a building, such as security related devices (e.g., alarms or alarm triggering devices) or particular types of controllers for a window tinting system (e.g., master controllers).

In the case of sensor data transmission, blockchain procedures may be employed to control transmission of data used to control building conditions (e.g., temperature in a room), and/or data that is not necessarily used to control building conditions but nevertheless should be deemed valid for a different purpose (e.g., data utilized in making an assessment of building conditions and/or compliance, or data used for later mining by a building enterprise or a third party). Accordingly, at least in some implementations, service terms can be enforced at the level of individual network communications. One example in which such enforcement may be advantageous may relate to instances in which there are different subscribers to data services. Thus, in implementations, a service may be programmed so that only a subgroup of subscribers may receive certain data types. To bring about such a capability, a system implementing the data service may be capable of differentiating among subscribers, so that subscriber 1, for example, receives data stream 1, while subscriber 2 receives data stream 2, and so forth. A variety of data transmission conditions are possible depending on the subscriber or on the subscriber's particular service plan. In these situations, a blockchain procedure may operate to enforce various service conditions by applying different rule sets for different data/subscriber combinations. The blockchain procedure may operate to enforce the conditions by considering individual data transmissions and deciding on a transmission-by-transmission basis whether to allow data or instructions to be communicated along a building services network as requested.

Thus, service-based rules, which describe blockchain enforcement of data services in accordance with predetermined agreements between, for example, a cellular subscriber and a cellular voice/data services carrier, may be implemented at a network transmission level. For example, data paths and/or permissible subscribers of a data service may be enforced according to a particular contract or other type of agreement. For example, in particular implementations, permissible network end points can be defined for particular types of communications services. In some implementations, permitted devices that can provide data to a customer are defined in an agreement, which may be stored utilizing a distributed ledger. Permissible data paths, which may also be specified via a distributed ledger, may be defined for transmitting data from such devices to particular customers and/or to remote locations such as cloud-based servers. In one example, cellular subscriber A may be obligated to utilize the resources of a particular cellular carrier (e.g., Sprint). In another example, cellular subscriber A may be permitted to utilize a network path that avoids potential network bottlenecks, such as by avoiding the routing of cellular communications traffic through an intervening master controller. Rather, a cellular subscriber may be permitted to utilize a more direct link to a cellular infrastructure external to a building. Any such constraints and/or permissions may be enforced (e.g., permitted or denied) at the network transmission level via a blockchain technique, which may operate to append one or more proof transactions to a distributed ledger. In further examples, quality-of-service (including data traffic latency and/or security settings) may be defined in a contract and enforced or implemented via blockchain evaluation of transmission of individual messages. In such implementations, a blockchain rule set stored in a distributed ledger may specify that certain data is to be assigned relatively low priority, thus permitting certain data or information types to be transmitted utilizing a relatively high latency communications channel For example, if an output signal from a temperature sensor is likely to be relevant to a master controller to permit monitoring temperature sensor output signals over a duration of an entire day, a rule set of a building services network may indicate that temperature parameters are to be sent with relatively high latency, e.g., every 10 seconds.

Similarly, a ledger distributed among a peer group of computing elements of a building services network may be utilized to ensure compliance with a particular contract or rule set established for a particular type of sensor. For example, in certain implementations, a building master controller (such as master controller 140 of FIG. 1) may be configured to obtain sensor data (e.g., temperature, humidity, carbon dioxide concentration, and so forth) from one or more locations within a building at a certain frequency (e.g., one sample per minute, one sample per five minutes, or the like). Thus, if one or more sensors begins to transmit sensor readings at higher frequencies, (e.g., one sample per second), a peer group of computing elements of a building services network may determine that such increased frequency does not meet one or more terms and/or conditions of an agreement to transmit sensor readings at a particular frequency. Accordingly, in response to consulting a ledger distributed among the peer group of computing elements, the peer group may take action to reject sensor readings that are in excess of the predetermined limit.

In particular implementations, a method for enforcing service terms at a level of individual network communications may proceed in a manner similar to that of FIG. 6, which pertains to an example method of authenticating a service to be performed by a building services network, according to an implementation. Such a method may begin with an identification of a network transaction, or a group of network transactions, which are to be authenticated utilizing a blockchain technique. Thus, for example, a method of enforcing service terms may begin, in a manner similar to that of 610 of FIG. 6, with identifying that carbon dioxide measurements from a portion of a building are requested to be transmitted to a citywide environmental health monitoring authority. In another example, a method of enforcing service terms may begin with identifying that temperature/humidity measurements are to be sent to a utility company.

A method for enforcing service terms may continue in a manner similar to that of 620 of FIG. 6, with identifying a peer group to participate in blockchain analysis to authenticate/validate individual network communications. In particular implementations, a peer group may exclusively include, for example, network elements owned or leased by (or at least under the control of) a particular tenant of a building. In certain implementations, a peer group may exclusively include a subgroup of sensors that perform one or more common functions. Thus, for example, a transaction relating to transmission of images captured by one or more perimeter security cameras may exclusively involve validation by a peer group of camera-equipped security devices.

The method for enforcing service terms may continue, in a manner similar to that of 630 of FIG. 6, with providing relevant service parameters for evaluating rules to sensors and/or network elements of a building services network. Thus, for example, if carbon dioxide measurements within particular building areas have been requested, relevant service parameters may relate to particular areas and/or room identification numbers within a building at which carbon dioxide measurements have been performed or are scheduled to be performed. In another example, if captured images are requested, such as from perimeter security cameras captured during a previous night, relevant service parameters may relate to precise camera resources, camera fields of view, etc.

The method for enforcing service terms may continue, in a manner similar to that of 640 of FIG. 6, with members of a peer group applying enforcement rules to relevant service parameters. In certain implementations, members of a peer group may perform one or more comparisons between relevant service parameters and terms and conditions of an agreement to determine if requested data (e.g., sensor measurements, captured images, and so forth) is permitted under the agreement. For example, a peer group may determine if a communication is permitted by a service contract of a particular cellular subscriber, by an agreement to provide analytics services, an agreement to provide low-latency communications channels, and so forth. Similar to that of 650 of FIG. 6, a determination may be made as to whether a consensus for a network transaction, such as supplying requested data from sensors/data elements of a building services network. If a consensus has been reached, similar to operation 660 of FIG. 6, a network transaction may be permitted to take place, similar to that of operation 670 of FIG. 6. Conversely, if a consensus among members of a peer group has not been reached, a network transaction may be denied or prevented, similar to that of operation 680 of FIG. 6.

In particular implementations, operations associated with obtaining blockchain consensus from members of a peer group, which may permit authentication/verification of individual network transactions, may impose undue burdens on network communication operations. Such burdens may be particularly apparent during blockchain consensus operations taking place utilizing lower-bandwidth networks and/or utilizing less-robust processors. Accordingly, in some implementations, streamlined modes of authentication may be employed. For example, while a building services network may be possess a capability to authenticate/validate sampling of output signals from a particular sensor or group of sensors, it may be problematic for the building services network to authenticate transactions occurring at much higher sampling rates, such as the video frame sampling rates utilized during videoconferencing sessions. Thus, in an implementation, a mode of streamlining may involve an initial determination that communications from particular devices, or transmissions between two particular devices, are to be trusted. In particular implementations, such “trust” may bring about an automatic approval of communications, such as transmissions from particular devices, when such communications exclusively involves previously authenticated devices. For example, a prior authentication of a particular device and/or software running on the device (e.g., review and authentication of source code) may be sufficient to allow all or at least certain types of communications originating from such devices. Such communications may be entitled to automatic approval when, for example, the sending device holds a valid key (e.g., established at a manufacturing site). In such cases, the data transmitted by the device may be automatically deemed valid by the receiving device.

In some implementations, messages can be encapsulated to address the possibility that an unauthorized entity could intercept, such as by way of a man-in-the-middle attack in which an attacker secretly relays and possibly alters communication between two communicating devices. In some cases, communications can be implemented via an SSL, or other secure connection through to a host. Communications may be made by way of an HTTPS message, message queuing, or other types of messages that include a secure wrapper.

In some implementations, it may be advantageous to utilize two or more distributed ledgers, which may be held by a corresponding number of groups of network elements. For example, a first group of digital architecture elements 125A through 125N of FIG. 1 may operate as a first peer-to-peer network, which may permit the group of digital architecture elements to validate data transmissions and other types of transactions originating from within sensors controlled by one of elements 125A through 125N. For example, if digital architecture elements 125A through 125N control temperature sensors located in western-facing rooms of a multistory building, it may be advantageous for elements 125A-125N to form a peer-to-peer network in which a ledger may be distributed to each of elements 125A-125N. Thus, for example, if abnormally high temperatures are reported by a specific digital architecture element, such abnormally high temperatures may be rejected by other digital architecture elements also located in western-facing rooms of the multistory building. Such oversight, which may involve a peer-to-peer network of digital architecture elements consulting a distributed ledger, may ensure that such reported abnormally high temperatures do not unnecessarily activate a building's central air-conditioning. In a similar fashion, additional computing elements of a building services network may utilize a ledger, distributed among additional peer groups, to detect outlier parameters, which may ensure that other types of reported parameters (e.g., humidity, carbon dioxide level, and so forth) remain within physically-possible limits. Of course, peer groups that participate in blockchain or blockchain-like processing at need not be directly impacted by or otherwise associated with a parameter whose value is being validated. For example, one or more peers charged with validating a particular type of sensor value need not be located in a region where a sensed value is measured. So long as a peer can access a set of rules that can be evaluated when determining whether to validate a value, the peer may participate in the evaluation.

### IMPLEMENTATION EMBODIMENTS AND CONCLUSION

It should be understood that the certain embodiments described herein can be implemented in the form of control logic using computer software in a modular or integrated manner Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Python using, for example, conventional or object-oriented techniques. The software code may be stored as a series of instructions, or commands on a computer-readable medium, such as a random-access memory (RAM), a read-only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

Although the foregoing disclosed embodiments have been described in some detail to facilitate understanding, the described embodiments are to be considered illustrative and not limiting. One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

What is claimed is:

1. A method of authenticating a network element to communicate on a building services network, the method comprising:
at a manufacturer of the network element, identifying and storing an encryption key in a nonvolatile memory of the network element;
storing the encryption key and a unique identifier of the network element in a secure data repository;
coupling the network element to the building services network at a building site; and
authenticating the network element at the building site by comparing the encryption key stored in the nonvolatile memory of the network element with the encryption key in the secure data repository.

2. The method of claim 1, further comprising, after coupling the network element to the building services network, commissioning the network element by determining a correspondence between (a) an installed location of the network element at the building site, and (b) an identifier of the network element coupled to the building services network.

3. The method of claim 1, wherein the encryption key is derived utilizing unique parameters of the network element.

4. The method of claim 3, wherein the unique parameters of the network element correspond to a serial number of the network element or to a universal unique identifier of a processor of the network element.

5. The method of claim 1, further comprising, after authenticating the network element, storing identifying parameters of the network element in a distributed ledger.

6. The method of claim 5, wherein storing the identifying parameters comprises transmitting the identifying parameters to a plurality of network elements coupled to the building services network.

7. The method of claim 1, wherein the network element corresponds to a temperature sensor, a humidity sensor, a glass breakage sensor, a movement detector, a carbon dioxide detector, a carbon monoxide detector, a fire detection sensor, a camera, or an air quality sensor.

8. A method of providing a service in a building having a building services network, wherein the service is implemented using the building services network, the method comprising:
receiving a request to activate the service;
via a peer-to-peer network, evaluating the received request for compliance with one or more defined criteria pertaining to authentication of the service;
responsive to evaluation by the peer-to-peer network of the received request, determining that the service is to be activated; and
activating the service.

9. The method of claim 8, wherein the service comprises a wireless communications service.

10. The method of claim 9, wherein the service comprises a Wi-Fi service, a cellular telephone service, a Bluetooth service, or Citizens Broadband Radio Service band.

11. The method of claim 8, wherein activating the service comprises providing the service, via the building services network, exclusively to a portion of the building.

12. The method of claim 8, wherein activating the service comprises providing the service, via the building services network, exclusively to a first tenant of the building.

13. The method of claim 8, wherein the peer-to-peer network comprises a plurality of peer devices coupled to the building services network.

14. The method of claim 13, wherein the peer-to-peer network comprises network elements owned by, leased by, or under the control of, an enterprise providing the service to at least a portion of the building via the building services network.

15. The method of claim 8, wherein evaluating the received request for compliance comprises performing a blockchain procedure.

16. The method of claim 8, wherein the one or more defined criteria pertaining to authentication of the service comprises application of analytics to measurements performed by sensors of the building services network, transmission of measurements performed by sensors to one or more public utility companies, or transmission of measurements performed by sensors to a health and safety monitoring service.

17. A method of authenticating a communication between a first network element and a second network element, wherein the first network element is installed in a building and coupled to a building services network, the method comprising:
determining that the communication is being transmitted, or is to be transmitted, from the first network element over the building services network;
via a peer-to-peer network, evaluating the communication for compliance with one or more defined criteria pertaining to authentication of the communication;
via evaluation by the peer-to-peer network of the communication, determining that the communication is not to be delivered to the second network element; and
preventing transmission of the communication to the second network element.

18. The method of claim 17, wherein the first network element is a temperature sensor, a humidity sensor, a glass breakage sensor, a movement detector, a carbon dioxide detector, a carbon monoxide detector, a fire detection sensor, a camera, or an air quality sensor.

19. The method of claim 17, wherein the peer-to-peer network comprises a plurality of devices from a peer group or a peer subgroup of network elements coupled to the building services network.

20. The method of claim 19, wherein the peer group or subgroup of network elements corresponds to devices owned or controlled by an enterprise tenant.

21. The method of claim 17, wherein evaluation for compliance, via the peer-to-peer network, comprises performing a blockchain procedure.

22. The method of claim 17, wherein the first network element corresponds to a sensor, and wherein the communication includes a measurement performed by the sensor.

23. The method of claim 22, wherein the first network element corresponds to a processor, or a device comprising a processor, and wherein the communication includes a result of an analytic derived from one or more measurements performed by the sensor.

24. The method of claim 23, wherein the analytic comprises a compliance report for a government entity, a standards body, or a certification entity.

25. The method of claim 17, wherein the one or more defined criteria pertaining to authentication of communications comprises determining if the communication is permitted by a cellular subscriber service contract, by an agreement to provide analytics services, or an agreement to provide low-latency communications channels.
